(19) United States
(12) Patent Application Publication
(10) Pub. No.: US 2021/0315193 A1
(43) Pub. Date: Oct. 14, 2021

(54) BIO-ROBOTIC DEVICE FOR LURING AND KILLING HEMATOPHAGOUS ARTHROPODS

(71) Applicant: HUMAN CENTERED AND BIO-INSPIRED IDEAS FOR DAILY LIFE S.R.L. IN SIGLA HUBILIFE S.R.L., Pontedera (Pisa) (IT)

(72) Inventors: David ANGUILLESI, Vicopisano (Pisa) (IT); Peppuccio LA PLACA, Pontedera (Pisa) (IT); Donato ROMANO, Bernalda (Matera) (IT); Cesare STEFANINI, Cascina (Pisa) (IT)

(73) Assignee: HUMAN CENTERED AND BIO-INSPIRED IDEAS FOR DAILY LIFE S.R.L. IN SIGLA HUBILIFE S.R.L., Pontedera (Pisa) (IT)

(21) Appl. No.: 17/282,293

(22) PCT Filed: Oct. 25, 2019
(86) PCT No.: PCT/IB2019/059177

§ 371 Date: Apr. 1, 2021

(30) Foreign Application Priority Data
Oct. 26, 2018 (IT) 102018000009833

(51) Int. Cl. A01M 1/20; A01M 1/02

(52) U.S. Cl. CPC A01M 1/2016; A01M 2200/012; A01M 1/023

(57) ABSTRACT

The present invention concerns a device for luring and killing hematophagous arthropods in its inside, in an effective and selective way, without emitting to the outside harmful substances to human health and the environment, comprising multi-sensory lures for the aforesaid arthropods that guide them inside the device where 5 there is an eradication means for the target arthropod.

### FIELD OF THE INVENTION

The present invention relates in general to the field of control means for controlling harmful insects, more specifically for hematophagous arthropods endowed with a biting-sucking buccal apparatus, such as in particular mosquitoes. Specifically, the present invention relates to a device adapted to lure and kill such insects, and to the related method.

### BACKGROUND OF THE INVENTION

Several biting insects, such as for examples mosquitoes, horseflies and sand flies, and other arthropods such as ticks, are called “hematophagous” since they feed on the blood of animals and human beings, guided, in the search for this food source, by the smell and heat of the human or animal body.

These insects have a biting-sucking buccal apparatus that, aside specific characteristics that can vary from species to species, has features that are common to all hematophagous insects: in particular, in these insects, the appendages forming the buccal apparatus are called “stylets” since they are very thin and capable of penetrating into the skin tissue of the host animal; these stylets also form channels for the passage of liquids, and the introduction of saliva into the host, with an anticoagulant and slightly anaesthetic effect, as well as for the suction of the sucked blood.

The piercing of tissues by the insect, beside inducing irritation and itching on the skin, brings the much more serious possibility of transmitting pathogenic microorganisms from one host to another through the insect's saliva.

Despite decades of intense research to eradicate or at least reduce this risk, hematophagous insects and mosquitoes in particular still play a crucial role among vector organisms of medical and veterinary relevance. This is also due to a rapid uncontrolled urbanization, to the increase of international travels and trades, the intensification of agricultural crops and finally environmental changes, which have led to the rapid and involuntary spread of invasive mosquito species. The latter are vectors of major pests and pathogens which, in the most severe cases, can be lethal. It has been reported that more than 830,000 people worldwide lose their lives every year as a result of diseases transmitted by mosquito bites, including malaria, typhus, yellow fever, encephalitis, West-Nile, Dengue, Zika virus disease, etc.

Most of these deaths are due to the spread of malaria, 212 million new cases are recorded every year and causes 429 thousand deaths (data relative to the year 2015). The populations with the highest incidence are those living in poverty in tropical and subtropical areas. The situation is worsened by the fact that the recently introduced malaria vaccine has only shown a transient protection. Furthermore, cases of malaria, even fatal ones, have been recorded in European countries. In addition, the Dengue virus puts at risk 3,900 million people in 128 countries and lymphatic filariasis is still classified among the most important tropical diseases. At the same time, Zika virus outbreaks in America and the Pacific are increasingly threatening public health due to the connection of the arbovirus with foetal microcephaly and neurological complications. The spread of arboviral diseases is constant and difficult to manage.

To address this situation, plans and guidelines have been formulated both at the international organizations level, such as the WHO plan whose purpose is to realign insect control programmes in the various countries. The aim of the plan is to reduce of 75% mortality related to the insect and of 60% the incidence by 2030. At the national level, all Italian regions have adopted resolutions with public expenditure plans for the larvicidal treatment of mosquitoes. Last but not least, various private “non-profit” organizations, such as Bill & Melinda Gates Foundation with its Target Malaria Project, are investing huge amounts of capital in the research for new strategies aimed at sterilizing female mosquitoes through the application of advanced techniques of genetic engineering.

Conventional strategies based on dispersion, especially in domestic environments, of chemicals with insecticidal action (which poison mosquitoes by contact or inhalation) or with repellent action (which, because of an unpleasant smell, keep mosquitoes away) are however also harmful to people. These products, if inhaled, ingested or if coming into contact with eyes, can have consequences ranging from headache, irritation, cough, nausea, vomiting, skin rashes, bronchitis, asthma, up to lung cancer. Furthermore, the protection action exerted by these conventional systems is short, with an estimated duration after the treatment of 3-4 hours maximum.

Therefore, repellent and insecticidal approaches present serious limitations both for the health of people and for the preservation of the environment, as well as for the real effectiveness of the means employed due to the short effective time of protection, the effects of resistance to the treatments detected and the capacity of the adult mosquitoes to move away from the newly treated area.

Recently, based on experimental studies on the identification of substances or more in general stimuli that are attractive to mosquitoes, some luring devices emitting carbon dioxide (CO₂), considered to be the most attractive molecule for these insects, have been developed, able to lure mosquitoes, draw them with a fan and let dehydrate.

These systems, due to the number of lured insects, are for external use only, they can be placed at a distance of at least 100 metres from the areas frequented by people. Furthermore, they are not selective systems for hematophagous insects, but also capture non-harmful animal species, and have a negative impact on CO₂ emissions in the atmosphere due to the use of gas cylinders that develop large amounts of CO₂ as a result of combustion processes.

Other devices that produce CO₂ are known: they exploit the photocatalysis principle to transform polluting substances present in the air into calcium and sodium nitrates together with CO2, but at a marginal and irrelevant extent to lure mosquitoes.

Even the light is considered a long-range luring element for mosquitoes, hence the development of devices that emit light radiations to lure these insects, subsequently killing them through electrified grids or draw them with special suction fans. Even these devices, in use for several years already, have proved to be ineffective since they are used in the vicinity of people, on which mosquitoes continue to feed by intercepting their presence through other sensory channels including heat and olfactory stimuli. These devices, besides not being very effective against mosquitoes, were also harmful to other non-target animals, mainly lured by light stimuli.

For the reasons set out above, the need for a truly effective system in the control of biting hematophagous insects, in particular mosquitoes, which is not harmful to the health of people and other animal species, nor to the environment, remains strong.

### SUMMARY OF THE INVENTION

The Applicant has now developed a new device that is effective in the control of the hematophagous arthropods, in particular of the hematophagous insects, more in particular of mosquitoes, which does not have the drawbacks highlighted above for the known systems. Advantageously, the device of the invention, thanks to the combined use of a poisoned “skin-like” membrane acting as a decoy, and other scientifically recognized multi-sensory stimuli, effectively and selectively lures only the selected arthropod in order to kill it.

Therefore, a subject of the present invention is a device for luring and killing hematophagous arthropods as defined in the first of the claims appended thereto.

A method for luring and killing hematophagous arthropods, as defined in the independent claim 10 appended thereto, represents a further subject of the present invention.

Other important characteristics of the device and of the method for luring and killing hematophagous arthropods according to the invention are reported in the following detailed description.

### BRIEF DESCRIPTION OF THE FIGURES

FIG. 1: sectional view of the device according to the invention, in its preferred embodiment thereof, illustrated in detail below;

FIG. 2: schematic representation of the flows of stimuli/insects during the operation of the device of FIG. 1.

### DETAILED DESCRIPTION OF THE INVENTION

Within the context of the present invention “hematophagous arthropod” means any insect or other arthropod provided with a biting-sucking buccal apparatus, which feeds on human or animal blood, such as for examples mosquitoes, horseflies, sand flies, and ticks. Below this arthropod can also be referred to as the “target arthropod”, in the plural “target arthropods”.

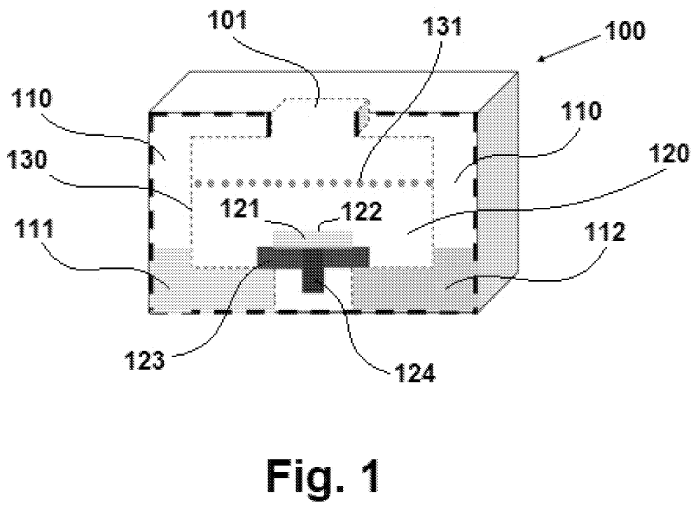

With reference to the aforesaid figures, and in particular for the moment in FIG. 1, the present device for luring and killing target arthropods comprises a container 100 provided with an opening 101 and comprising at least two chambers inside, a first chamber 110 comprising at least one agent attractive to the target arthropod and a second chamber 120 comprising at least one means for eradicating the target arthropod, wherein this second chamber 120 is directly communicating with the outside through the aforesaid opening 101 while the first chamber 110 is communicating only with the second chamber 120 through separation walls 130 provided with holes 131. Preferably, these intercommunication holes between the two chambers 110 and 120 are distributed on the separation walls 130 to maximize the emission in the second chamber 120 of the luring agent for the target arthropod at the eradicating means.

According to a particular embodiment of the present device, the means for eradicating the target arthropod is an eradication means by electromagnetic energy selected for example between microwaves, laser emission, and the like.

In the present device, illustrated in the appended figures, the eradication means in the second chamber 120 comprises a receptacle 121 with an insecticidal fluid covered by a “skin-like” membrane 122 suitable to be penetrated by the biting buccal apparatus of the target arthropod, fixed to the container so as to be always in contact with the surface of the fluid. This insecticidal fluid is typically a liquid, but other fluid forms suitable for the purpose, such as for example gel or foams, can be used in the present device. The insecticidal fluid comprises preferably, in addition to one or more active ingredients with an insecticidal action, also one or more desirable substances appreciated by the target arthropods so as to increase their attraction to the fluid itself. In a preferred aspect, these desirable substances are blood-mimicking substances which however exclude the presence of blood or plasma. In the insecticidal fluid of the device according to the invention the active ingredients with insecticidal action can be conventional insecticidal substances and/or innovative molecules, including metallic nanoparticles, having an insecticidal action.

In an embodiment of the invention, the receptacle 121 with the insecticidal fluid can be easily removed from the container 100 for maintenance operations of the device such as replacing or topping up the insecticidal fluid.

According to the invention, by a “membrane adapted to be penetrated by the biting buccal apparatus of the target arthropod” is meant any membrane capable of being crossed by the biting stylets of the buccal apparatus of the hematophagous arthropods, and is preferably a microporous membrane—i.e. having pores of micrometric dimensions—with a thickness of less than 1 millimetre. The membrane 122 can be for example a silicone membrane.

It has been observed by the inventors how the system described above with fluid covered by the membrane adapted to be penetrated by the biting buccal apparatus of the target arthropod, can reproduce a “skin-like” substrate, which simulates human skin and stimulates, together with several luring agents present inside the container, the so-called “probing” display, that is the natural behaviour of biting hematophagous insects consisting in the insertion of the buccal stylets into the skin tissue of the host in order to suck the blood thereof. Furthermore, the particular microgeometry of the membrane makes the typical selection of the present device towards the arthropods with biting-sucking buccal apparatus, allowing in fact the insecticidal fluid to be only accessed by the hematophagous arthropods provided with such an apparatus.

The one or more luring agent(s) present in the first chamber 110 can be selected for example from among the substances known as highly attractive to the target arthropod such as carbon dioxide, nonanal, lactic acid, butyric acid, ammonia and mixtures thereof. Preferably, the at least one luring agent in the chamber 110 of the present device is a mixture of carbon dioxide, nonanal, lactic acid, butyric acid and ammonia, which has been particularly attractive to mosquitoes.

Advantageously, the first chamber 110 can comprise several sections suitably separated from each other but all communicating with the second chamber 120 through the aforesaid holes 131; according to a preferred embodiment of the present invention, the first chamber 110 comprises a section 111 from which CO₂ is emitted and a section 112 containing at least one further luring agent of the target arthropod, preferably a mixture of lactic acid, ammonia, nonanal and butyric acid.

According to the invention, the emission of carbon dioxide in the present device is preferably carried out by non-pathogenic microorganisms, including yeasts of the Saccharomyces genus and lactic bacteria, capable of producing CO₂ through respiration processes that are very similar to those of the humankind.

In an embodiment of the invention, the present device further comprises, in the second chamber 120, a heating means 123 which allows bringing the temperature of the fluid to values around 37° C., similar to those of the temperature of the human body, and creating a further luring element for the target arthropod towards the insecticidal fluid. The heating means 123 can comprise for example electrical resistors and temperature sensors controlled by an electronic control unit.

Furthermore, the present device can advantageously also comprise a stirrer means—not shown in the figure—of the insecticidal fluid contained in the receptacle 121; this stirrer, which can be for example a permanent magnet, allows the fluid to be stirred in order to maintain uniform the concentration of the insecticidal ingredients present in the same fluid. According to an embodiment of the present device, it further comprises an electric micromotor 124 which, through magnetic coupling, allows the stirrer means present in the receptacle 121 to move and stir the insecticidal fluid. Also, the magnetic means can be controlled by an electronic control unit, equal to or different from the one controlling the heating means 123.

The above-described functionalities of the device can be realized by means of an electrical power supply both of the plug-in type through a low voltage mains power supply unit, and with batteries, and through a renewable source in the case of use of the device outdoors.

The inlet opening 101 of the device of the invention, for example suitably sized to a few cm in diameter, can advantageously be protected for example through a raised cover, to allow the passage of the target arthropods towards the inside of the container but at the same time protecting the opening from atmospheric agents, for example preventing the introduction of foreign bodies into the container.

In addition to the possibility of easy extraction of the receptacle 121 from the container, it is envisaged that the device of the invention can be made with a modular structure so that single components, once they are broken or used up, can be easily replaced even individually, independently of the other components of the device. For this purpose, an electronic control unit can be comprised in the device which envisages sensors able of determining, for example, the residual level of insecticidal active ingredients in the fluid of the receptacle 121 and an alarm system for the user on the depletion of the active ingredients and the need to recharge the container with fresh fluid. This technology can easily be integrated with smart home systems and with portable devices for personal use such as smartphones, etc.

Advantageously, the present device can further comprise a detection system for detecting the entrance of the target arthropod through the opening 101 based on acoustic detections and on machine learning algorithms that interpret the noise produced by the arthropod and, subsequently, can proceed with its eradication.

A method for luring and killing hematophagous arthropods as described below is a further object of the invention and can be achieved by using the aforesaid device. This method comprises the following steps:
i) luring the target arthropods, through an inlet opening 101, into a container 100 with at least a first chamber 110 and a second chamber 120 communicating with each other by separation walls 130 with holes 131, by emitting at least one luring agent for the target arthropod contained in the aforesaid first chamber 110, through said holes 131, thus guiding the arthropod into the second chamber 120 comprising an eradication means for the arthropod;
ii) killing the arthropods positioned on said eradication means by stimulating them to suck insecticidal fluid through a membrane (122) adapted to be penetrated by appendages of said buccal apparatus of the target arthropods, placed on the surface of said insecticidal fluid contained in a receptacle (121) inside said second chamber (120), said receptacle (121) with membrane (122) and insecticidal fluid constituting said eradication means.

In other words, in the present method the eradication means provides for the use of a membrane 122 adapted to be penetrated by the biting buccal apparatus of the target arthropod, which covers a receptacle 121 containing an insecticidal fluid, as described above; the membrane in fact simulates the skin tissue of the host and stimulates the target arthropod to exert on it the natural probing action, i.e. the insertion of the buccal stylets through the membrane and sucking the insecticidal fluid, then quickly dying in proximity of the device.

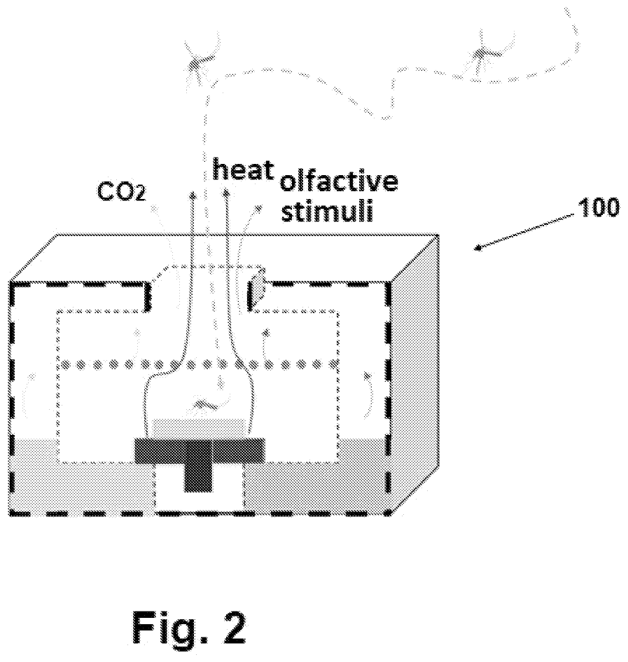

With reference in particular to FIG. 2, appended thereto, the flow of target arthropods towards the inside of the present device in its preferred embodiment of FIG. 1, lured by the flow of multi-sensory luring agents emitted from inside the device, in particular carbon dioxide and other olfactory stimuli, and heat, is shown schematically.

The device of the present invention, besides having a considerable effectiveness in its function of luring and killing the target arthropods, and in particular mosquitoes, has the advantage of being selective, thanks to the use of substances and stimuli that are attractive to the aforesaid target arthropods. In other words, the device is not harmful to other animal species. Likewise, since it does not emit harmful substances, it is not harmful to people or the environment.

A further advantage of the present device lies in the fact that it is compact, with reduced volume, and that it can therefore be arranged in any space and moved according to need.

Yet a further advantage of the present device is the possibility of integrating other products and devices inside the device thanks to its compatibility/complementarity.

Yet a further advantage of the device and of the relative method is that, contrary to the conventional insecticidal chemical means, it does not promote resistance phenomena in the target arthropods.

The present invention has been described herein with reference to a preferred embodiment. It is to be understood that there may be other embodiments that relate to the same inventive nucleus, all falling within the scope of protection of the claims provided below.

1. A device for luring and killing hematophagous arthropods having a biting-sucking buccal apparatus, said device comprising a container provided with an opening and comprising at least two chambers inside, a first chamber comprising a luring agent attractive to said arthropods and a second chamber comprising an eradication means for the target arthropod, wherein said second chamber is directly communicating with the outside through said opening while said first chamber is communicating only with said second chamber through their separation walls provided with holes and wherein said eradication means in said second chamber comprises a receptacle with an insecticidal fluid covered by a membrane adapted to be penetrated by appendages of said buccal apparatus of the target arthropod, placed on the receptacle so as to be in contact with the surface of said fluid.

2. The device according to claim 1, wherein said holes are distributed on said separation walls so as to maximize the emission towards said second chamber of said luring agent for the target arthropod at said eradication means.

3. The device according to claim 1, wherein said insecticidal fluid comprises, in addition to one or more active ingredients having an insecticidal action, one or more desirable substances appreciated by said arthropods.

4. The device according to claim 1, wherein said luring agent for said arthropods is selected from among carbon dioxide, nonanal, lactic acid, butyric acid, ammonia and mixtures thereof.

5. The device according to claim 1, wherein said first chamber comprises a section from which CO₂ is emitted and a section containing a further luring agent for said arthropods, said sections and being separated from each other but both communicating with said chamber through said holes.

6. The device according to claim 5, wherein said CO₂ emission is carried out by non-pathogenic microorganisms, such as yeasts of the Saccharomyces genus and lactic bacteria, capable of producing CO₂.

7. The device according to claim 1, further comprising, in said second chamber (120), a heating means (123) of said insecticidal fluid.

8. The device according to claim 1, further comprising, in said second chamber (120), a stirrer means of said insecticidal fluid.

9. The device according to claim 1, further comprising one or more electronic control units for monitoring and adjusting said heating means and said stirrer means.

10. The device according claim 1, wherein said insecticidal fluid is a liquid.

11. A method for luring and killing hematophagous arthropods having a biting-sucking buccal apparatus, comprising:
i) luring said arthropods, through an inlet opening, into a container comprising a first chamber and a second chamber communicating with each other by separation walls with holes, by emitting a luring agent for said arthropods from said first chamber, through said holes (131), thus guiding the arthropod into said second chamber comprising an eradication means for said arthropods;
ii) killing said arthropods positioned on said eradication means by stimulating them to suck insecticidal fluid through a membrane adapted to be penetrated by appendages of said buccal apparatus of the target arthropods, placed on the surface of said insecticidal fluid contained in a receptacle inside said second chamber said receptacle with membrane and insecticidal fluid constituting said eradication means.

12. The device according to claim 5, wherein said further luring agent for said arthropods is a mixture of lactic acid, ammonia, nonanal, and butyric acid.

13. The device according to claim 1, further comprising an alarm system on the depletion of said active ingredients.
